(19) United States
(12) Patent Application Publication
(10) Pub. No.: US 2026/0211758 A1
(43) Pub. Date: Jul. 23, 2026

(54) SYSTEMS AND METHODS FOR AUTOMATICALLY GENERATING MULTI-LAYERED DIFFUSION IMAGES FOR APPLICATION PROGRAMMING INTERFACE REQUESTS IN A DISTRIBUTED SERVER SYSTEM

(71) Applicant: BANK OF AMERICA CORPORATION, Charlotte, NC (US)

(72) Inventors: Pratap Dande, Saint Johns, FL (US); Naga Vamsi Krishna Akkapeddi, Charlotte, NC (US); Saurabh Arora, Gurugram, Haryana (IN); Sandeep Kumar Chauhan, Hyderabad, Telangana (IN); Elvis Nyamwange, Fate, TX (US)

(73) Assignee: BANK OF AMERICA CORPORATION, Charlotte, NC (US)

(21) Appl. No.: 19/029,222

(22) Filed: Jan. 17, 2025

(51) Int. Cl. G06F 9/54

(52) U.S. Cl. CPC G06F 9/547

(57) ABSTRACT

Systems, computer program products, and methods are described herein for automatically generating multi-layered diffusion images for application programming interface requests in a distributed server system. The present disclosure is configured to identify at least one header associated with at least one of a sender server or a recipient server, wherein the at least one header comprises text data; apply the at least one header to a first diffusion engine; generate, by the first diffusion engine, a first diffusion image based on the text data; apply the first diffusion image to a second diffusion engine; and generate, by the second diffusion engine, a second diffusion image based on the recipient server and the first diffusion image.

### TECHNOLOGICAL FIELD

Example embodiments of the present disclosure relate to systems and methods automatically generating multi-layered diffusion images for application programming interface requests in a distributed server system.

### BACKGROUND

In distributed server environments there exists a need to prevent man in the middle attacks when data transmissions are transmitted between servers, such as when application programming interface (API) headers are accessed during these transmissions and their data is accessible by bad actors. Thus, there exists a great need to prevent hackers and other secure data from being accessed from these API headers during server transactions.

Applicant has identified a number of deficiencies and problems associated with automatically generating multi-layered diffusion images for application programming interface requests in a distributed server system. Through applied effort, ingenuity, and innovation, many of these identified problems have been solved by developing solutions that are included in embodiments of the present disclosure, many examples of which are described in detail herein.

### BRIEF SUMMARY

Systems, methods, and computer program products are provided for automatically generating multi-layered diffusion images for application programming interface requests in a distributed server system.

In one aspect, a system for automatically generating multi-layered diffusion images for application programming interface requests in a distributed server system is provided. In some embodiments, the system may comprise: a memory device with computer-readable program code stored thereon; at least one processing device operatively coupled to the memory device and at least one communication device, wherein executing the computer-readable code is configured to cause the at least one processing device to: identify at least one header associated with at least one of a sender server or a recipient server, wherein the at least one header comprises text data; apply the at least one header to a first diffusion engine; generate, by the first diffusion engine, a first diffusion image based on the text data; apply the first diffusion image to a second diffusion engine; and generate, by the second diffusion engine, a second diffusion image based on the recipient server and the first diffusion image.

In some embodiments, the first diffusion image comprises data associated with a plurality of transmission hops between the sender server and the recipient server. In some embodiments, the plurality of transmission hops is based on a plurality of servers, and wherein the plurality of servers will receive the second diffusion image and reverse diffuse the second diffusion image to access data of the first diffusion image or the second diffusion image.

In some embodiments, the first diffusion image is reverse diffused at each transmission hop between the sender server and the recipient server.

In some embodiments, the second diffusion image is only reverse diffused by the recipient server. In some embodiments, the second diffusion image is fully reverse diffused at the recipient server, and wherein the fully reversed diffused second diffusion image comprises a view of the at least one header by the recipient server.

In some embodiments, the first diffusion engine and the second diffusion engine comprise a generative artificial intelligence (AI) engine.

In some embodiments, the first diffusion image and the second diffusion image comprise a shared link. In some embodiments, the first diffusion image and the second diffusion image are stored in an image database, and wherein the image database is accessed by a server based on the shared link.

In some embodiments, the first diffusion image is a common diffusion image associated with server associated with each transmission hop between a sender server and the recipient server, and wherein the second diffusion image is associated with both the common diffusion image and a server-specific diffusion image.

Similarly, and as a person of skill in the art will understand, each of the features, functions, and advantages provided herein with respect to the system disclosed hereinabove may additionally be provided with respect to a computer-implemented method and computer program product. Such embodiments are provided for exemplary purposes below and are not intended to be limited.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for automatically generating multi-layered diffusion images for application programming interface requests in a distributed server system, in accordance with an embodiment of the disclosure;

FIG. 2 illustrates an exemplary generative AI subsystem 200, in accordance with an embodiment of the disclosure;

FIG. 3 illustrates a process flow for automatically generating multi-layered diffusion images for application programming interface requests in a distributed server system, in accordance with an embodiment of the disclosure; and

FIG. 4 illustrates an exemplary flow diagram for automatically generating multi-layered diffusion images for application programming interface requests in a distributed server system, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

In distributed server environments there exists a need to prevent man in the middle attacks when data transmissions are transmitted between servers, such as when application programming interface (API) headers are accessed during these transmissions and their data is accessible by bad actors. Thus, there exists a great need to prevent hackers and other secure data from being accessed from these API headers during server transactions.

Accordingly, the present disclosure provides for the identification of at least one header associated with at least one of a sender server or a recipient server, wherein the at least one header comprises text data; the application of the at least one header to a first diffusion engine; and the generation, by the first diffusion engine, of a first diffusion image based on the text data. Further, the disclosure provides for the application the first diffusion image to a second diffusion engine; and the generation, by the second diffusion engine, of a second diffusion image based on the recipient server and the first diffusion image.

The disclosure provides a system for generating multi-layered diffusion images for application programming interface requests. The disclosure provides a system that extracts API call headers as a text and passes it through a first diffusion engine that converts the text to an image that can be read and understood at each hop within the API call path. Additionally, and importantly, the system further inputs the image to a secondary diffusion engine that diffuses the entire image that is specific to the end application of the API call, such that only the end application can reverse diffuse the image to gather the necessary data to complete the API call. Thus, and based on this multi-layer diffusion process, the system can securely protect the data in the image from bad actors, man in the middle attacks, misappropriation, or hacking, while also promoting uniform server use in the API call path by confirming that a plurality of servers will be used to complete the API call and share the necessary processes for this completion, instead of one server or a small number of servers completing all the steps and over-using their resources.

What is more, the present disclosure provides a technical solution to a technical problem. As described herein, the technical problem includes the data security as data is transmitted within a distributed server environment. The technical solution presented herein allows for a multi layered diffusion modelling for secured and faster transactions leveraging generative AI and multiple diffusion engines. In particular, the disclosure provided herein is an improvement over existing solutions to the identified problems, (i) with fewer steps to achieve the solution, thus reducing the amount of computing resources, such as processing resources, storage resources, network resources, and/or the like, that are being used, (ii) providing a more accurate solution to problem, thus reducing the number of resources required to remedy any errors made due to a less accurate solution, (iii) removing manual input and waste from the implementation of the solution, thus improving speed and efficiency of the process and conserving computing resources, (iv) determining an optimal amount of resources that need to be used to implement the solution, thus reducing network traffic and load on existing computing resources. Furthermore, the technical solution described herein uses a rigorous, computerized process to perform specific tasks and/or activities that were not previously performed. In specific implementations, the technical solution bypasses a series of steps previously implemented, thus further conserving computing resources.

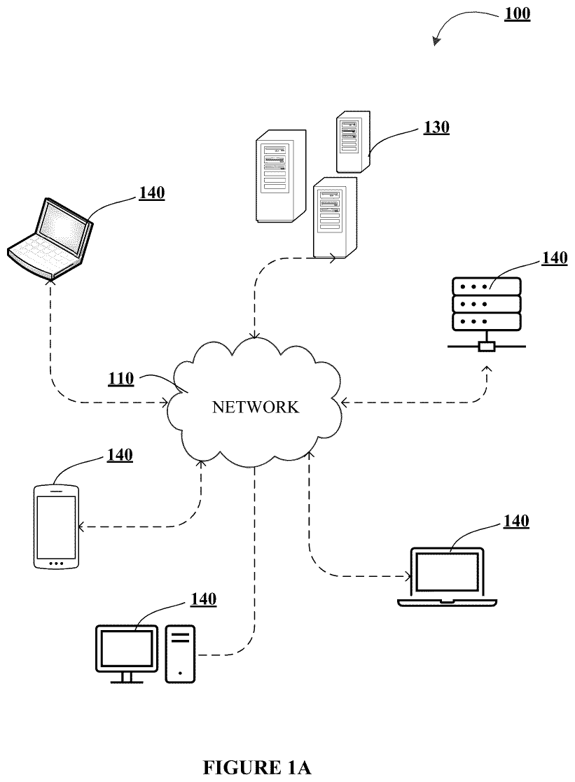

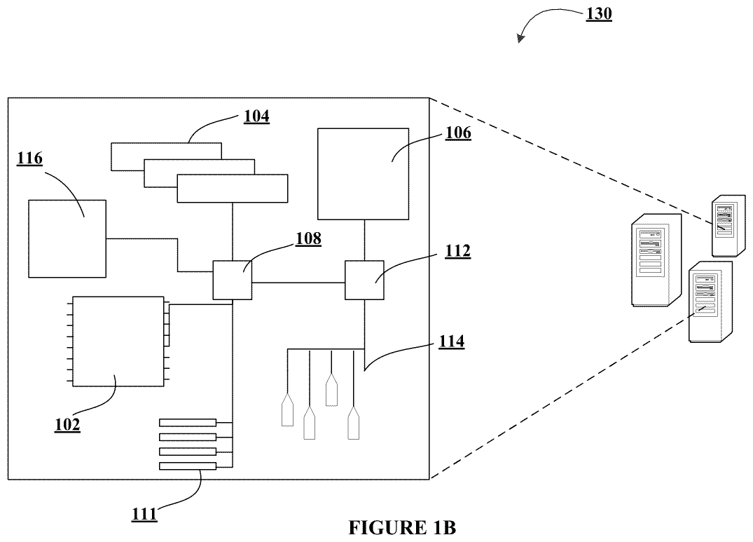

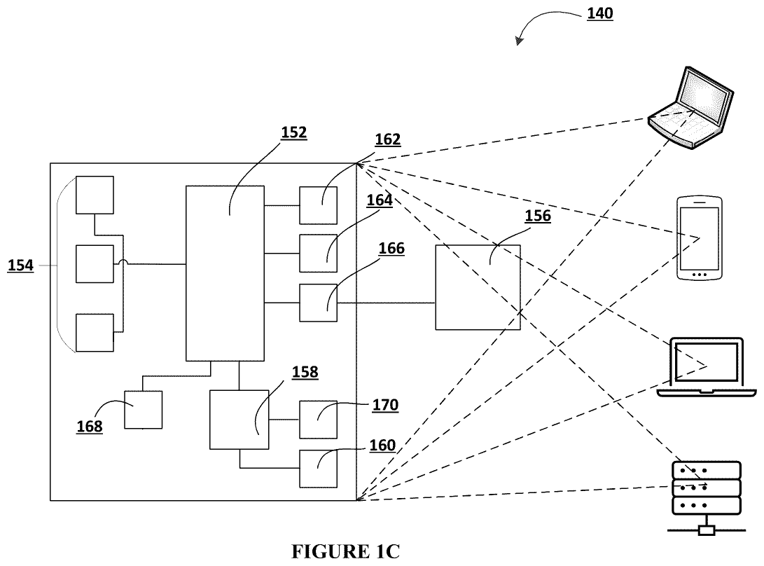

FIGS. 1A-1C illustrate technical components of an exemplary distributed computing environment for automatically generating multi-layered diffusion images for application programming interface requests in a distributed server system 100, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation-and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

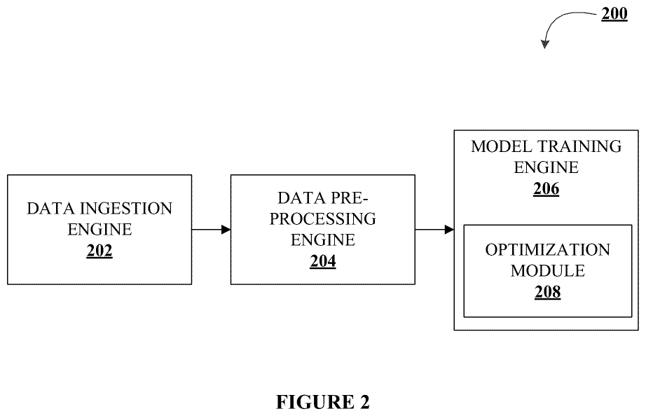

FIG. 2 illustrates an exemplary generative AI subsystem 200, in accordance with an embodiment of the invention. The generative AI subsystem 200 may include a data ingestion engine 202, a data pre-processing engine 204, and a model training engine 206. It should be understood that the generative AI subsystem 200 is merely an example, and other embodiments may include more, fewer, or different components depending on the specific requirements and implementations of the system. For instance, additional engines for data validation, feature selection, or distributed computing may be integrated into the subsystem, or certain components described herein may be consolidated or omitted based on system performance objectives. Therefore, the generative AI subsystem 200 should not be considered limiting and may be adapted to various configurations within the scope of the invention.

The data ingestion engine 202 may identify various internal and/or external data sources to generate, test, and/or integrate new features for training the generative AI model. These internal and/or external data sources (e.g., text corpora, web-based text data, document repositories, or decentralized text storage system) may be initial locations where the data originates or where physical information is first digitized. In addition to conventional data sources, the data ingestion engine 202 may support decentralized storage systems, such as blockchain-based data sources, and privacy-preserving methods such as differential privacy. The data ingestion engine 202 may identify the location of the data and describe connection characteristics for access and retrieval of data. In some embodiments, data is transported from each data source using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the data sources may include Enterprise Resource Planning (ERP) databases that host data related to day-to-day business activities such as accounting, procurement, project management, exposure management, supply chain operations, and/or the like, mainframes that are often the entity's central data processing center, edge devices that may be any piece of hardware, such as sensors, actuators, gadgets, appliances, or machines, that are programmed for certain applications and may transmit data over the internet or other networks, and/or the like.

Depending on the nature of the data, the data ingestion engine 202 may move the data to a destination for storage or further analysis. Typically, the data may be in varying formats as the data comes from different sources, including RDBMS, other types of databases, S3 buckets, CSVs, or from streams. For a large language model (“LLM”), text data may originate from sources such as web scrapes, social media, large public text datasets, or the like. Since the data may come from different places, the data needs to be cleansed and transformed so that the data may be analyzed together with data from other sources. The data may be ingested in real-time, using stream processing, in batches using a batch data warehouse, or in a combination of both. Stream processing may be used to process continuous data streams (e.g., data from edge devices) by computing on data directly as it is received, and filtering the incoming data to retain specific portions that are deemed useful by aggregating, analyzing, transforming, and/or ingesting the data. On the other hand, the batch data warehouse may collect and transfer data in batches according to scheduled intervals, triggered events, and/or any other logical ordering.

The generative AI subsystem 200 may utilize one or more machine learning techniques to generate new content. In machine learning, the quality of data and the useful information that may be derived therefrom directly affects the ability of the machine learning model to learn. The data pre-processing engine 204 may implement advanced integration and processing steps needed to prepare the data for machine learning execution, including tokenization, text normalization, and/or removal of irrelevant elements like HTML tags in web-based data, especially for LLM training. This may include modules to perform any upfront data transformation to consolidate the data into alternate forms by changing the value, structure, and/or format of the data by using generalization, normalization, attribute selection, aggregation, and text-specific transformations such as stemming and lemmatization to data clean by filling missing values, smoothing the noisy data, resolving the inconsistency, removing outliers, and/or any other encoding steps as needed. In some embodiments, the data pre-processing engine 204 may perform real-time pre-processing at the edge via edge computing devices, allowing for the transformation and reduction of data prior to transmission to centralized locations, thereby reducing latency and conserving network bandwidth.

In addition to improving the quality of the data, the data pre-processing engine 204 may transform categorical data into numerical formats that may be suitable for machine learning algorithms. In this regard, the data pre-processing engine 204 may use techniques such as one-hot encoding or label encoding depending on the nature of the categorical variables and the intended use of the data.

In some embodiments, the data pre-processing engine 204 may also include dimensionality reduction techniques, where the number of input features is reduced while retaining the most relevant information. In this regard, the data pre-processing engine 204 may include methods such as Principal Component Analysis (PCA) or apply feature selection algorithms to remove redundant or irrelevant features, thereby reducing the computational complexity of the model training phase. Feature selection may be particularly beneficial in datasets with a high number of features, ensuring that the generative AI models do not overfit to noise or irrelevant details. The pre-processed data output from the data pre-processing engine 204 may then be fed into the model training engine 206.

The model training engine 206 may be responsible for training the generative AI models using the pre-processed data from the data pre-processing engine 204. The model training engine 206 may implement various machine learning algorithms, including but not limited to Generative Adversarial Networks (GANs), Variational Autoencoders (VAEs), transformers, diffusion models, and/or other specialized architectures depending on the specific requirements of the system. These models may be used in a broad range of applications, such as LLMs for text generation, image generation models, video synthesis models, audio generation models, and/or the like. The model training engine 206 may optimize these models by continuously adjusting their internal parameters based on the patterns and relationships identified within the data.

In some embodiments, the model training engine 206 may include a training data handler, which manages the partitioning of the pre-processed data into training, validation, and testing datasets. The training data may be used to update the model's parameters, while the validation and testing datasets may be reserved to evaluate the model's performance during and after training. The model training engine 206 may support various data-handling strategies, such as cross-validation or random shuffling, to ensure that the model generalizes well and is not overfitting to the training data.

In embodiments involving large language models, the model training engine 206 may utilize transformer-based architectures, such as the Transformer, BERT, GPT, or the like. Transformer models rely on mechanisms like self-attention to capture dependencies between words in a sequence, regardless of their distance from one another. The self-attention mechanism allows the model to weigh the importance of different words in a sentence and establish complex relationships important for understanding context. During training, the model may process vast amounts of text data and learn to predict the next word or token in a sequence based on the input context. This training process allows LLMs to generate coherent text, complete sentences, translate languages, or answer questions based on learned patterns from the data.

The transformer-based LLMs may be trained using autoregressive (e.g., GPT) or masked-language modeling techniques (e.g., BERT). In autoregressive models, the training process may include predicting the next word in a sequence by progressively revealing more context to the model. The model iteratively improves its predictions based on its performance during prior iterations. Masked-language modeling involves masking certain words in a sentence and training the model to correctly predict the masked words based on surrounding context. Both approaches enable LLMs to capture intricate patterns in human language, improving their ability to handle tasks such as summarization, translation, and text generation. Loss functions like cross-entropy loss may be used to optimize the model's performance by comparing predicted tokens with the actual tokens in the dataset to guide the model to minimize prediction errors during training, as described in further detail herein.

In embodiments involving image generation models, the model training engine 206 may utilize transformer-based architectures, such as Vision Transformers (ViTs) or generative adversarial networks (GANs). Vision Transformers rely on self-attention mechanisms to process images as sequences of patches rather than whole images, allowing the model to capture spatial dependencies and patterns across the image. During training, the model may be exposed to large datasets containing diverse image types to learn features like textures, edges, and shapes. The model may then generate or reconstruct images by interpreting these patterns and applying learned spatial relationships. GAN-based models may also be used, where a generator network creates images, and a determinator network evaluates their realism, enabling the model to improve through adversarial training.

Image generation models may employ various training techniques, such as pixel-wise reconstruction or adversarial training, depending on the architecture. Pixel-wise reconstruction methods involve learning to reconstruct an image from its corrupted or downscaled version, optimizing the model to minimize the difference between the predicted and actual pixels (e.g., using mean squared error as the loss function). Adversarial training, often used with GANs, involves iteratively improving the generator network to produce images that are increasingly indistinguishable from real images, based on feedback from the determinator network. These approaches allow the model to capture complex visual features, enabling applications such as image synthesis, enhancement, and style transfer.

For video generation models, the model training engine 206 may employ transformer-based architectures like Video Transformers or GAN-based models specifically designed for handling temporal sequences. Video Transformers use self-attention mechanisms to model dependencies not only between pixels within a single frame but also across frames, allowing them to understand temporal relationships and motion patterns in videos. The model may be trained on large video datasets, enabling it to learn and reproduce dynamic changes and interactions between objects over time. GAN-based video models may incorporate spatiotemporal networks to evaluate the realism of generated video sequences, optimizing the model to produce continuous and coherent frames.

Video generation models may utilize spatial-temporal modeling techniques or adversarial training for generating realistic motion and video sequences. Spatial-temporal modeling involves learning the spatial features within each frame while simultaneously capturing the temporal dependencies between frames, optimizing the model's ability to predict future frames or complete missing sequences. Loss functions like mean squared error or perceptual loss may be applied to reduce discrepancies between predicted and actual frames. Adversarial training, on the other hand, may involve a generator creating video sequences and a determinator evaluating their realism, encouraging the generator to improve by minimizing the discrepancy identified by the determinator. These techniques may enable video generation models to create coherent and realistic sequences, useful in applications such as video synthesis and animation.

In audio generation models, the model training engine 206 may utilize architectures such as Audio Transformers or recurrent neural networks (RNNs) like WaveNet, designed to handle sequential and waveform data. Audio Transformers leverage attention mechanisms to capture relationships between segments of audio, allowing them to model temporal dependencies and predict the next audio sample based on previous context. During training, the model may process large audio datasets containing diverse sound patterns to learn representations of different audio features, such as frequency, amplitude, and harmonics. This training enables the model to generate coherent audio sequences, including speech, music, or ambient sounds, by synthesizing these learned patterns.

Audio generation models may be trained using sequence modeling techniques or autoregressive methods, depending on the architecture. Sequence modeling techniques involve processing and predicting sequences of audio samples, optimizing the model to capture and reproduce temporal dependencies in sound. Autoregressive methods, such as those employed in WaveNet, focus on predicting each audio sample based on prior samples, progressively refining the generated audio sequence over multiple iterations. Loss functions like mean absolute error or cross-entropy loss may be used to minimize the error between predicted and actual audio samples, guiding the model to improve its accuracy. These approaches allow audio generation models to create continuous and realistic audio outputs, applicable in areas such as speech synthesis, music generation, and sound effect creation.

The reconstruction loss ensures that the difference between the original input and the reconstructed output is minimized, guiding the decoder to generate outputs that closely resemble the input data. The second component, KL divergence loss, regularizes the latent space by ensuring that the distribution of latent variables conforms to a predefined probabilistic distribution, often a Gaussian distribution. This constraint encourages the model to learn a well-organized and smooth latent space, allowing for meaningful sampling from this space during inference. By combining these loss functions, the VAE can learn a latent space that not only captures the underlying patterns in the data but also allows for the generation of novel outputs by sampling new points from this space. During the inference phase, the trained model can sample random points from the latent space to generate new, previously unseen data instances.

In training generative AI models, the model training engine 206, which includes an optimization module 208, may implement various optimization techniques to improve model performance and efficiency. The optimization module 208 is responsible for adjusting the model's internal parameters continuously, using feedback from relevant loss functions tailored to the application (e.g., text, image, audio, or video generation). Techniques such as gradient clipping, learning rate scheduling, and mixed-precision training are applied by the optimization module 208 to stabilize and fine-tune the training process. Gradient clipping may be used to stabilize the training process, especially in transformer-based models, by capping the magnitude of gradients to prevent them from becoming excessively large. Learning rate scheduling may involve gradually increasing the learning rate during initial training phases (warm-up) and then decaying it as training progresses to fine-tune the model's parameters more effectively. Mixed-precision training, which leverages lower-precision (e.g., float16) arithmetic while retaining higher precision (e.g., float32) for specific calculations, may be used to accelerate training and reduce memory consumption, enabling the model to scale efficiently even when trained on large datasets.

In some embodiments, the model training engine 206 may implement early stopping mechanisms to prevent overfitting. Early stopping monitors the generative AI model's performance on the validation dataset, halting the training process if the performance does not improve after a specified number of iterations. This ensures that the generative AI model does not continue training on noise or irrelevant patterns, which could degrade its performance on unseen data. The model training engine 206 may also support distributed training across multiple computing nodes, allowing the system to scale its computational resources as needed. Distributed training may involve splitting the generative AI model and data across multiple machines or GPUs, where each node processes a portion of the data and updates the model in parallel. This is particularly useful for large datasets or models that require significant computational power, such as deep generative models. The model training engine 206 may synchronize the updates across the nodes using techniques like synchronous or asynchronous gradient descent.

Once the generative AI model is trained, the model training engine 206 may save the final trained generative AI model in a persistent storage location for future use. In specific embodiments, metadata such as the number of epochs, the final loss values, and values of learned parameters may be logged for model versioning and/or retraining at a later stage. In some embodiments, the model training engine 206 may also implement transfer learning, where a pre-trained model is fine-tuned on a smaller, domain-specific dataset. This may reduce the amount of time and data required to train a new model, especially in cases where the available data is limited or highly specialized. The model training engine 206 may adjust the parameters of the pre-trained model to better align with the new dataset, while preserving the learned features from the original training.

In embodiments involving LLMs, new output is generated by sampling from the model's probability distribution of tokens, conditioned on the context provided as input. Transformer-based architectures, such as GPT, use an auto-regressive approach where the model predicts the next token in a sequence one step at a time, using previously generated tokens as input for subsequent predictions. The process starts with a prompt or an initial sequence of words, and the model iteratively generates new tokens, forming coherent sentences or paragraphs based on the learned context and language patterns. For masked-language modeling (e.g., BERT), new output may be generated by filling in masked parts of the input sequence, allowing the model to complete sentences or generate variations of the provided text. The generated output can be controlled by adjusting parameters such as heat, which influences the randomness of the token sampling, enabling the generation of diverse or deterministic responses.

In image generation models, such as those using ViTs or GANs, new output is generated by sampling from the learned distribution in the model's latent space. For GANs, the generator network creates an image by transforming random noise vectors into structured image outputs through a series of layers that learn visual features like shapes, textures, and colors. The generated image is then refined through adversarial feedback from the determinator network, which assesses the realism of the generated output. For transformer-based image models, the process may involve reconstructing images by assembling patches based on the learned dependencies between them. Input conditions, such as prompts describing desired features or specific noise vectors, guide the generation process, allowing for the creation of customized images or variations of existing visual styles. These models may also generate images based on style transfer techniques or predefined templates, synthesizing images that align with the characteristics present in the training data.

Video generation models utilize spatiotemporal dependencies to synthesize new video sequences based on the patterns learned during training. In transformer-based architectures, the model may generate video frames sequentially, predicting the next frame based on the input frames and the temporal context established by prior frames. GAN-based models, specifically designed for video synthesis, may sample noise vectors or use a sequence of frames as input, transforming these into continuous and temporally coherent video outputs through the generator network. The determinator evaluates the temporal consistency and realism of the output, ensuring the generated video mimics the motion dynamics and object interactions present in real-world video data. Such models may also use attention mechanisms to focus on critical elements within each frame and their evolution across time, facilitating realistic scene transitions and motion patterns. The generation process may include user-defined input such as initial frames, motion descriptions, or specific video attributes, providing control over the output.

Audio generation models, including Audio Transformers or autoregressive architectures like WaveNet, generate new audio sequences by predicting audio samples based on learned dependencies in sequential sound data. For autoregressive models, the generation process involves producing each audio sample one at a time, conditioned on previously generated samples, allowing the model to build complex audio patterns such as speech, music, or ambient sounds. The model starts with an initial segment or a random seed and uses its learned parameters to predict and synthesize subsequent samples, constructing a continuous audio waveform. Audio Transformers, on the other hand, may use attention mechanisms to identify important temporal segments within the input audio and synthesize new output based on these learned patterns. The user can control the type of audio generated by providing parameters such as pitch, tempo, or initial sound clips, enabling the model to generate outputs tailored to specific use cases like speech synthesis, music composition, or environmental sound generation.

In some embodiments, generative AI models may also integrate multiple modalities, enabling cross-modal generation where output in one modality influences or conditions the generation in another. For example, a video generation model may use text descriptions as input, synthesizing video content that aligns with the specified narrative or visual scene described. Similarly, image generation models may generate visual representations based on audio inputs, such as generating animations synchronized to musical rhythms or speech patterns. These cross-modal systems typically involve conditional GANs or multi-modal transformers, where the model processes input from one domain (e.g., text or audio) and learns to generate output in another domain (e.g., video or image) by aligning the patterns and dependencies between the different modalities. These models may allow users to generate complex, multimodal content based on combinations of inputs, such as using text prompts to control the visual and auditory elements of a video.

It will be understood that the embodiment of the generative AI subsystem 200 illustrated in FIG. 2 is exemplary and that other embodiments may vary. The generative AI subsystem 200, as well as its constituent elements, may vary, and modifications or alternative configurations may be implemented without departing from the broader scope of the invention. For instance, different machine learning algorithms, data sources, optimization techniques, or training methodologies may be employed depending on system requirements, application domain, and available computational resources. Furthermore, features and functionalities described in one embodiment may be combined with those of another embodiment as needed, and vice versa.

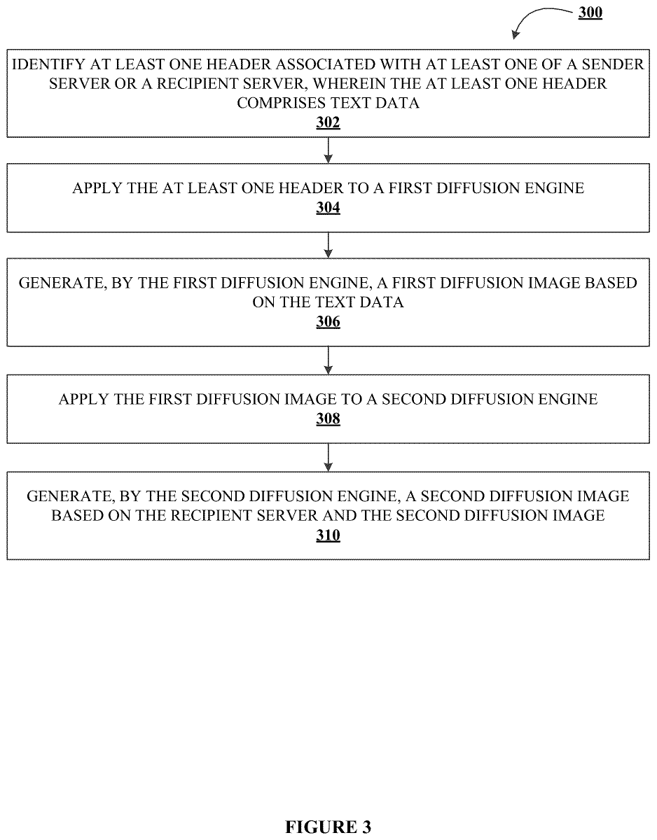

FIG. 3 illustrates a process flow 300 for automatically generating multi-layered diffusion images for application programming interface requests in a distributed server system, in accordance with an embodiment of the disclosure. In some embodiments, a system (e.g., similar to one or more of the systems described herein with respect to FIGS. 1A-1C) may perform one or more of the steps of process flow 300. For example, a system (e.g., the system 130 described herein with respect to FIG. 1A-1C) may perform the steps of process 300. Additionally, and in some embodiments, a generative AI engine, like the one shown and described above with respect to FIG. 2, may perform one or more of the steps of the process of process flow 300.

As shown in block 302, the process flow 300 may include the step of identifying at least one header associated with at least one of a sender server or a recipient server, wherein the at least one header comprises text data. For example, the system may identify at least one header associated with an application programming interface (API) call or request. Such a header may be used by a sender server and/or a recipient server to transmit the metadata associated with the API request between an originator (or sender server) to an end (or recipient server), and other servers or applications between the sender and recipient servers. In some embodiments, the header may comprise text data and/or metadata indicating the request and the desired response by one or more recipient servers (and/or one or more servers between the sender server and the recipient server). In some embodiments, the header may comprise text data related to information about the format of the request and the desired response (from the server that receives the header at each transmission hop and/or at the end of the transmission hops—the recipient server); authorization data for authorized users, servers, applications, and/or the like, for carrying out the request(s) of the header; response caching (e.g., caching each response by each server, in an instance where the header requests such caching); response cookies (e.g., servers transmit such cookies to clients, applications, and/or the like, and such response cookies may be requested by the header data); secure metadata; and/or the like.

As used herein, the phrase “transmission hops” refers to the path of data transmissions associated with a header as the header and its metadata is transmitted from a sender server to the recipient server. Additionally, and as used herein, the phrase “sender server” refers to the originator server that generates the header and its metadata. Further, and as used herein, the phrase “recipient server” refers to the final server that is intended to receive the header and its metadata and is authorized to access the metadata fully to complete the API request. Additionally, and as understood by a person of skill in the art, the term “server” may refer to a system or application that receives and processes the header fully and/or partially, and generates a response to the header.

Importantly, these headers must be protected from bad actors, data misappropriators, and man in the middle attacks, and thus, these headers, their text data and any underlying metadata must be secure and inaccessible to servers, applications, users, and/or the like, that do not have proper clearance. Therefore, and as a first step, the system may apply the at least one header (and its text data) to a first diffusion engine. Additionally, and upon generating a first diffusion image of the header, the system may additionally generate a second diffusion image based on the recipient server that will receive the header and based on the first diffusion image. Such a process is described in further detail below.

As shown in block 304, the process flow 300 may include the step of applying the at least one header to a first diffusion engine. For instance, the system may apply the at least one header (and its text data) to a first diffusion engine, whereby such a first diffusion engine may be configured to diffuse the text data and generate a first diffusion image. Thus, and in some such embodiments, the first diffusion engine may comprise a generative AI engine which may generate an image based at least in part on the text data from the header using diffusion principles.

As shown in block 306, the process flow 300 may include the step of generating, by the first diffusion engine, a first diffusion image based on the text data. For example, and in some such embodiments, the generative AI engine of the first diffusion engine may be pre-trained on historical images generated from historical headers, whereby such pre-training may comprise generating the image, adding noise to the generated image as part of the diffusion process (which may later be removed as part of the reverse diffusion process of the recipient server and transmission hop servers). In some embodiments, the first diffusion engine may comprise a common diffusion method, which may be shard and understood by all the servers of the transmission hops between the sender server and the recipient server. Thus, and by way of non-limiting example, when a transaction needs to pass multiple hops, each hop can validate on the header using either common diffusion (e.g., first diffusion principles) or combination of common diffusion and its own specific diffusion (e.g., first diffusion and second diffusion principles). Not every server at every hop needs to know all the levels of details on the header, so the content is visible and validated only if it is related to the application (e.g., only the content visible to the transmission hop servers is the content needed of the transmission hop servers to transmit the header to the next server in line and to complete any other requests). Thus, and in other words, the first diffusion image may comprise data associated with a plurality of transmission hops between the sender server and the recipient server (or common servers).

In some embodiments, the generation of the fist diffusion image further comprises a generation of a link which may link the first diffusion image that is separately stored in a storage repository or database and may be accessed using the first link by a server, application, and/or the like. In some embodiments, such a first link may be the same as a shared link that is shard between the first diffusion image and the second diffusion image. Thus, and in some embodiments, the first diffusion image and/or the second diffusion image may be stored in a database and/or repository configured to store these images and allow for access by one or more servers. In some embodiments, such a database may be an operational data store (ODS), which may be accessed by one or more servers based on the link generated with the first diffusion image and/or the second diffusion image. In some such embodiments, the first diffusion image and/or the second diffusion image may be stored based on a segment header image mapping and the link(s), whereby such segment header image mapping may segment the first diffusion image and/or the second diffusion image based on the underlying header metadata and/or text data (e.g., the images may be segmented based on the servers that will process which data during the transmission hops and at the recipient server). In some embodiments, based on the segment header image mapping and the generated link to specific image header is passed to pluggable diffusion gateway (such as a pluggable diffusion gateway at each server that receives the link associated with the first diffusion image and/or second diffusion image), and using this pluggable diffusion gateway, the server at the current transmission hop may access the header as the first diffusion image and/or second diffusion image stored in the ODS, and upon reverse diffusing the image, the server may route to the next transmission hop.

In some such embodiments, when the header hits the next server and/or application in the transmission path (transmission path of transmission hops), the application and/or server will need to validate the data protected by the first diffusion image or the second diffusion image. Thus, and in other words, the application and/or server may retrieve the diffused image (first diffusion image and/or second diffusion image) from a segmented ODS based on the link (where in some embodiments, the ODS may be segmented such that specific link take the server or application to a specified portion of the image to reverse diffuse), the application and/or server may apply reverse diffusion (based on the level the application or server needs to, meaning common or application/server specific or both) and validates the data within the image. Thus, and in some embodiments, the whole operation may be performed on unused/rarely used servers (e.g., image-based servers or others) for effective usage. Once the header is validated, the respective operation/request can be performed, and a response can be sent back to respective source application/sender server.

As shown in block 308, the process flow 300 may include the step of applying the first diffusion image to a second diffusion engine. For instance, and upon generating the first diffusion image, the system may apply the first diffusion image to the second diffusion engine for further diffusion processing and protection of the header metadata and/or text data. In some embodiments, such a second diffusion engine may comprise a generative AI engine similar to the generative AI engine described above with respect to FIG. 2 and the first diffusion engine. Additionally, and in some embodiments, the generative AI engine of the second diffusion engine may further be trained on historical data associated with one or more specific recipient servers. Such a further training on specific servers may allow the second diffusion engine to be a server or application specific diffusion engine, which is specific to the recipient application or server that is intended to receive the header and its metadata and/or text data.

Additionally, and by applying the first diffusion image to the second diffusion engine, the system may allow for multi-layered diffusion processing on the header which both protects the header from unallowed server access and/or application access but still allows for limited access by allowed servers and/or applications (e.g., using the first diffusion engine and the reverse diffusion process by these allowed servers and/or applications in the transmission path), and allowing for high access through reverse diffusion by the recipient server using the specific diffusion process and specific reverse diffusion process.

As shown in block 310, the process flow 300 may include the step of generating, by the second diffusion engine, a second diffusion image based on the recipient server and the second diffusion image. For example, the system may generate the second diffusion image—using the second diffusion engine—by adding additional noise and/or by modify the first diffusion image further by using a component specific diffusion process that is specific to the recipient server.

In some embodiments, and upon generating the second diffusion image, each transmission hop within the transmission path may access the link associated with the second diffusion image, and based on the capability of each server, each server may partially (using common reverse diffusion process) or fully (using the specific reverse diffusion and the common reverse diffusion processes) the second diffusion image. Thus, and in other words, the plurality of transmission hops may be based on a plurality of servers, and the plurality of servers may receive the second diffusion image and reverse diffuse the second diffusion image to access data of the first diffusion image or the second diffusion image, but the data that is accessed by each server may be specific to the type of server accessing the image (e.g., the servers at each transmission hop between the sender server and the recipient server may only access the common data needed to continue the transmission path and complete the required request). Further, and in other words, the second diffusion image may only be reverse diffused by the recipient server to fully show the data diffused by both the first diffusion engine and the second diffusion engine.

In some embodiments, the first diffusion image and the second diffusion image may comprise a shared link. Thus, and in some such embodiments, the first diffusion image and the second diffusion image are stored in an image database, and wherein the image database is accessed by a server based on the shared link In some embodiments, the first diffusion image and the second diffusion image may comprise the same link, such that the server, application, and/or the like accessing the link may use the same image and reverse diffuse the image (e.g., the second diffusion image) based on the server's, application's, and/or the like, reverse diffusion capabilities. For instance, and where a server that is not the sender server or the recipient server is part of the transmission process, then the server may use the link to access the second diffusion image in the storage configured to store the second diffusion image and may apply its reverse diffusion process to access the common data that has been encrypted by the first diffusion process, but not any of the data that is specifically diffused by the second diffusion engine. Thus, and in other words, the first diffusion image may be a common diffusion image associated with at least one server associated with each transmission hop between a sender server and the recipient server, and the second diffusion image is associated with both the common diffusion image and a server-specific diffusion image. Further, and in some such embodiments, the second diffusion image may be fully reverse diffused at the recipient server, and the fully reversed diffused second diffusion image comprises a view of the at least one header by the recipient server.

Thus, and in some such embodiments, the first diffusion image may be reverse diffused at each transmission hop between the sender server and the recipient server. Therefore, and in an embodiment where a second diffusion image has been generated based on the first diffusion image, the servers at each transmission hop may reverse diffuse the second diffusion image and only access the data needed by the servers to continue the transmission path and/or to generate the response needed at the server. Such a reverse diffusion of the server may comprise a reverse diffusion process of the data that was protected by the common diffusion engine (the first diffusion engine), but not a reverse diffusion of the data protected by the second diffusion engine. Such data that is protected by the second diffusion engine may only be reverse diffused by a recipient server that has the capability to specifically reverse diffuse the image.

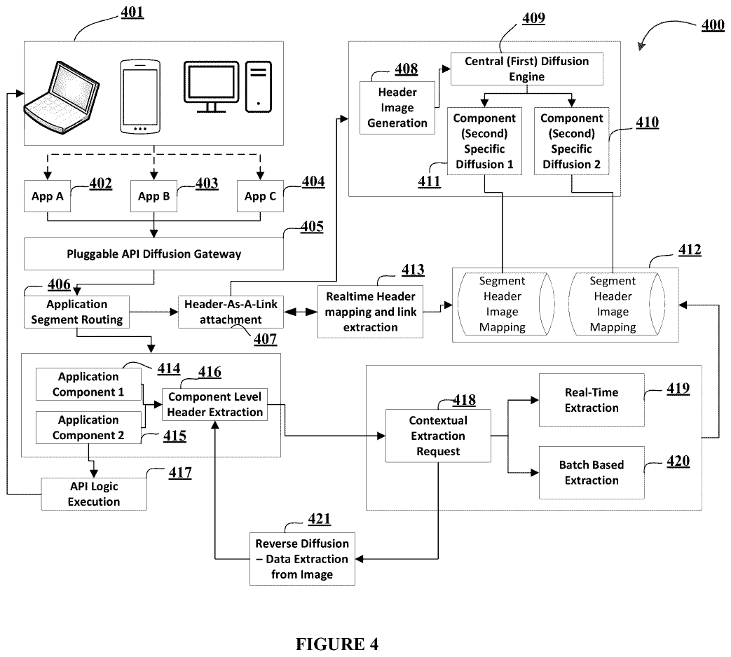

FIG. 4 illustrates an exemplary flow diagram 400 for automatically generating multi-layered diffusion images for application programming interface requests in a distributed server system, in accordance with an embodiment of the disclosure. In some embodiments, a system (e.g., similar to one or more of the systems described herein with respect to FIGS. 1A-1C) may perform one or more of the steps of exemplary flow diagram 400. For example, a system (e.g., the system 130 described herein with respect to FIG. 1A-1C) may perform the steps of exemplary flow diagram 400. Additionally, and in some embodiments, a generative AI engine, like the one shown and described above with respect to FIG. 2, may perform one or more of the steps of the process of exemplary flow diagram 400.

As shown in flow diagram 400, the headers may be transmitted from one or more computing devices 401 via one or more applications (App A 402, App B 403, App C 404, and/or the like) to a pluggable API diffusion gateway 405. In some embodiments, the pluggable API diffusion gateway may receive these headers as part of an API call, and such headers may comprise text data which is also passed to the pluggable API diffusion gateway. In some embodiments, the header and its text data and/or metadata may be transmitted to an application segment routing 406, which may generate a link for the header using the header-as-a-link attachment 407, may later be associated with at least one of the first diffusion image and/or the second diffusion image. Upon generating the link, the system may use a header image generation 408 to generate a first diffusion image using the central (first) diffusion engine 409, and then upon generating the first diffusion image, the first diffusion image may then be applied to a second diffusion engine (e.g., a component (second) specific diffusion 1 411 which is specific to a recipient server, a component (second) specific diffusion 2 410 which is specific to another recipient server, and/or the like). In this manner, the header and its data may be diffused by a common diffusion engine and then diffused using a specific diffusion engine that is specific to the recipient server of the original API call.

Further, and in some embodiments, the system may determine the segment header image mapping 412 for the second diffusion image that was generated. In such embodiments, the generated header images (e.g., the second diffusion images) may be stored in an ODS for real-time and/or near real-time extraction by each server or application in the transmission path. Additionally, and upon generating the segment header image mapping, the segment header image mapping and link may be extracted 413 and input back into the header as a link attachment 407, for future attachment with the header as the API call is transmitted along the transmission path.

Additionally, and in some embodiments, the application segment routing 406 may transmit the header as a link only to the server or application in the transmission path. By transmitting the header as a link only, the system may prevent any data exposure and thus, enhance data security, and allow for faster data transmission and processing by allowing for less data to be transmitted over any networks. Thus, and upon reaching the current or next transmission hop (e.g., application component 1 414 and/or application component 2 415), the application(s) or server(s) may extract the link using the component level header extraction 416. Additionally, and based on this extraction of the link, the server and/or application may request the header data for logic execution (e.g., may request the second diffusion image for reverse diffusion, the segment header image mapping, next transmission hop in the transmission path, and/or the like) using the contextual extraction request 418. Such a contextual extraction request 418 may access the segment header image mapping 412 using real-time extraction and/or batch based extraction (e.g., such that a batch of header images are extracted at once). Upon extracting the header image (the second diffusion image) and performing the reverse diffusion 421, the system may apply the reverse diffused data from the header image to the component level header extraction 416 which may be configured to allow the application or server to complete the request from the reverse diffused header image using the API logic execution 417.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for automatically generating multi-layered diffusion images for application programming interface requests in a distributed server system, the system comprising:
a memory device with computer-readable program code stored thereon;
at least one processing device operatively coupled to the memory device and at least one communication device, wherein executing the computer-readable code is configured to cause the at least one processing device to:
identify at least one header associated with at least one of a sender server or a recipient server, wherein the at least one header comprises text data;
apply the at least one header to a first diffusion engine;
generate, by the first diffusion engine, a first diffusion image based on the text data;
apply the first diffusion image to a second diffusion engine; and
generate, by the second diffusion engine, a second diffusion image based on the recipient server and the first diffusion image.

2. The system of claim 1, wherein the first diffusion image comprises data associated with a plurality of transmission hops between the sender server and the recipient server.

3. The system of claim 2, wherein the plurality of transmission hops is based on a plurality of servers, and wherein the plurality of servers will receive the second diffusion image and reverse diffuse the second diffusion image to access data of the first diffusion image or the second diffusion image.

4. The system of claim 1, wherein the first diffusion image is reverse diffused at each transmission hop between the sender server and the recipient server.

5. The system of claim 1, wherein the second diffusion image is only reverse diffused by the recipient server.

6. The system of claim 5, wherein the second diffusion image is fully reverse diffused at the recipient server, and wherein the fully reversed diffused second diffusion image comprises a view of the at least one header by the recipient server.

7. The system of claim 1, wherein the first diffusion engine and the second diffusion engine comprise a generative artificial intelligence (AI) engine.

8. The system of claim 1, wherein the first diffusion image and the second diffusion image comprise a shared link.

9. The system of claim 8, wherein the first diffusion image and the second diffusion image are stored in an image database, and wherein the image database is accessed by a server based on the shared link.

10. The system of claim 1, wherein the first diffusion image is a common diffusion image associated with at least one server associated with each transmission hop between a sender server and the recipient server, and wherein the second diffusion image is associated with both the common diffusion image and a server-specific diffusion image.

11. A computer program product for automatically generating multi-layered diffusion images for application programming interface requests in a distributed server system, wherein the computer program product comprises at least one non-transitory computer-readable medium having computer-readable program code portions embodied therein, the computer-readable program code portions which when executed by a processing device are configured to cause the processor to:
identify at least one header associated with at least one of a sender server or a recipient server, wherein the at least one header comprises text data;
apply the at least one header to a first diffusion engine;
generate, by the first diffusion engine, a first diffusion image based on the text data;
apply the first diffusion image to a second diffusion engine; and
generate, by the second diffusion engine, a second diffusion image based on the recipient server and the first diffusion image.

12. The computer program product of claim 11, wherein the first diffusion image is reverse diffused at each transmission hop between the sender server and the recipient server.

13. The computer program product of claim 11, wherein the second diffusion image is only reverse diffused by the recipient server.

14. The computer program product of claim 11, wherein the first diffusion image and the second diffusion image comprise a shared link.

15. The computer program product of claim 14, wherein the first diffusion image and the second diffusion image are stored in an image database, and wherein the image database is accessed by a server based on the shared link.

16. A computer implemented method for automatically generating multi-layered diffusion images for application programming interface requests in a distributed server system, the computer implemented method comprising:
identify at least one header associated with at least one of a sender server or a recipient server, wherein the at least one header comprises text data;
apply the at least one header to a first diffusion engine;
generate, by the first diffusion engine, a first diffusion image based on the text data;
apply the first diffusion image to a second diffusion engine; and
generate, by the second diffusion engine, a second diffusion image based on the recipient server and the first diffusion image.

17. The computer implemented method of claim 16, wherein the first diffusion image is reverse diffused at each transmission hop between the sender server and the recipient server.

18. The computer implemented method of claim 16, wherein the second diffusion image is only reverse diffused by the recipient server.

19. The computer implemented method of claim 16, wherein the first diffusion image and the second diffusion image comprise a shared link.

20. The computer implemented method of claim 19, wherein the first diffusion image and the second diffusion image are stored in an image database, and wherein the image database is accessed by a server based on the shared link.
